(19) United States
(12) Patent Application Publication
(10) Pub. No.: US 2005/0275521 A1
(43) Pub. Date: Dec. 15, 2005

(54) Vehicle signal light assembly

(76) Inventor: Shih-Hsiung Li, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/864,843

(22) Filed: Jun. 9, 2004

(51) Int. Cl. B60Q 1/26

(52) U.S. Cl. 340/468; 340/436

(57) ABSTRACT

A vehicle signal light assembly includes a casing to be securely mounted on a vehicle body, light bulbs received in the casing for lighting and heating effects, and at least one sensor received in the casing for obstacle detection. The light bulbs are able to melt snow accumulations on the sensor whereby the sensor is not detrimentally affected.

### BACKGROUND OF THE INVENTION

1. Field of the Invention

The present invention relates to a vehicle signal light assembly, and more particularly to a vehicle signal light with light bulbs received in the casing and at least one sensor received in the through hole of the casing such that heat from the light bulb is able to melt any snow accumulation outside the casing to enable the sensor to detect obstacles properly and accurately when the vehicle is reversing.

2. Description of Related Art

Vehicles are equipped with signal lights to indicate to other drivers the direction change about to be made. Therefore, the signal lights are crucial to the safety of all vehicle drivers. Furthermore, most modern vehicles are equipped with sensors in the bumpers to detect obstacles in the moving direction. However, due to the severe weather situations, sensors often are blocked by snow accumulation. As a consequence of the sensor blockage by the snow accumulation, driving on snowy days is still dangerous. To remove the snow accumulation manually is both time consuming and labor inefficient.

To overcome the shortcomings, the present invention tends to provide an improved signal light assembly to mitigate the aforementioned problems.

### SUMMARY OF THE INVENTION

The primary objective of the present invention is to provide an improved signal light assembly with at least one sensor received in the casing of the signal light assembly such that the snow accumulation problem is solved by the heat from the light bulbs of the signal light.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the signal light assembly of the present invention;

FIG. 2 is a schematic cross sectional view of the assembled signal light assembly of the present invention;

FIG. 3 is a schematic view showing the application of the present invention in a vehicle; and

FIG. 4 is a schematic view showing the heat from the light bulbs melts the snow accumulation outside the sensor.

### DETAILED DESCRIPTION OF THE PREFERRED EMBODIMENT

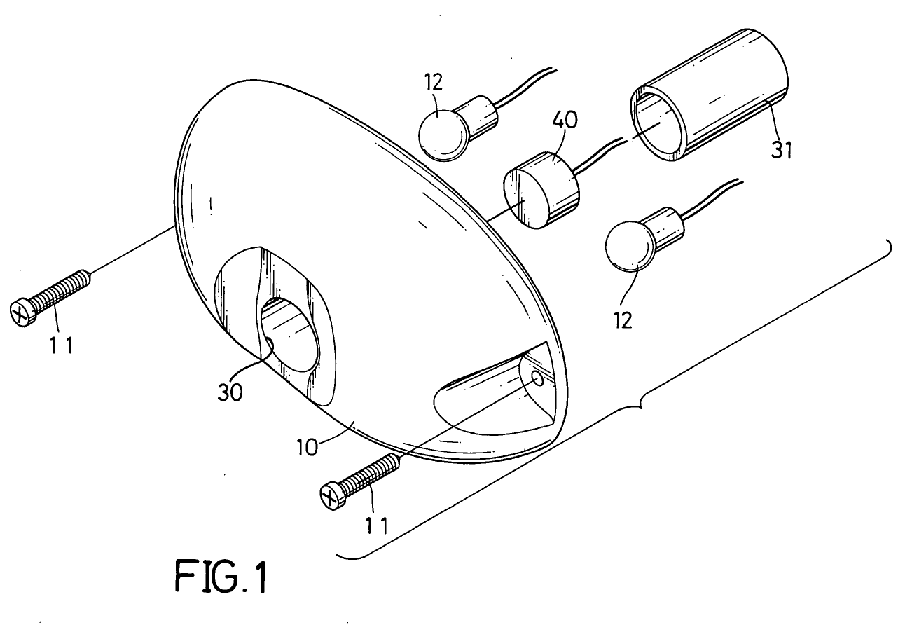

With reference to FIG. 1, the vehicle signal light assembly in accordance with the present invention includes a casing (10), light bulbs (12), a rubber sleeve (31) and at least one sensor (40).

The casing (10) has multiple threaded bolts (11) for mounting the casing (10) on the vehicle body, and at least one through hole (30) defined through the casing (10) (one through hole (30) is defined in this embodiment).

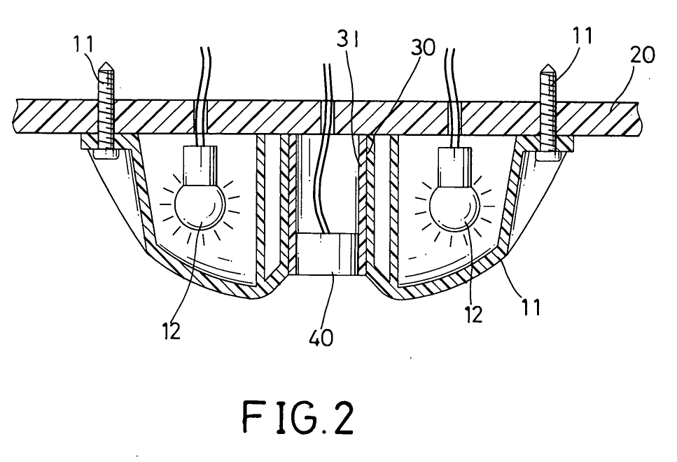

With reference to FIG. 2, the light bulbs (12) are securely received in the casing (10) for lighting and heating effects. The rubber sleeve (31) is interference fitted in the through hole (30) and the at least one sensor (40), preferably an ultrasonic sensor, is received in the through hole (30) to be surrounded by the rubber sleeve (31) such that the rubber sleeve (31) is able to prevent water seepage and thus avoid damage to the sensor function. The ultrasonic sensor functions as a radar device in that it detects obstacles around the vehicle, especially at the rear of the vehicle, and enables the driver to maneuver the vehicle safely around the obstacle.

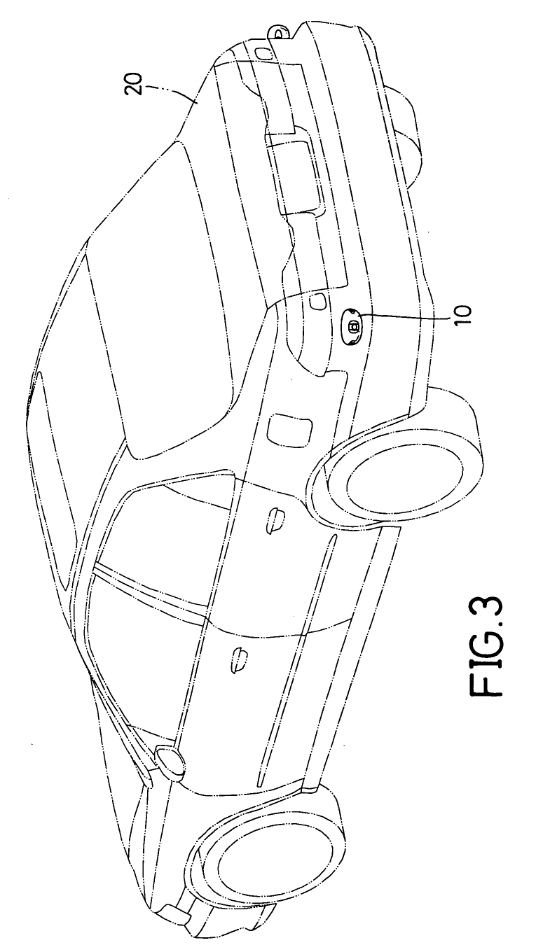

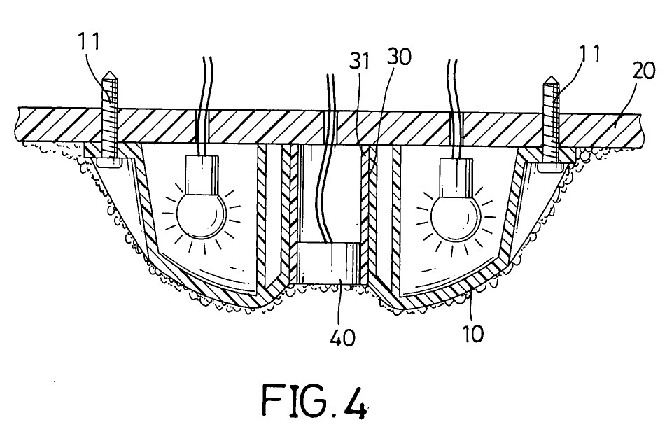

With reference to FIGS. 3 and 4, when the signal light assembly of the present invention is mounted on a vehicle (20), the heat from the light bulbs (12) is able to melt the snow accumulation outside the sensor (40) to allow the sensor (40) to function normally.

Therefore, even when the weather is bad and is snowing heavily, the sensor (40) can still function normally without the chance that the sensor (40) will be blocked or damaged by the snow. Thus, in particularly difficult driving conditions, the driver is still able to maneuver the vehicle safely despite the potential for distortion of radar signals.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A vehicle signal light assembly comprising:
a casing to be securely mounted on a vehicle body;
light bulbs received in the casing for lighting and heating effects; and
at least one sensor received in the casing for obstacle detection.

2. The vehicle signal light assembly as claimed in claim 1, wherein the casing has at least one through hole defined through the casing to securely receive therein the at least one sensor.

3. The vehicle signal light assembly as claimed in claim 1 further comprising a rubber sleeve to surround the at least one sensor.

4. The vehicle signal light assembly as claimed in claim 2 further comprising a rubber sleeve to be interference fitted in the at least one through hole to surround the at least one sensor.

5. The vehicle signal light assembly as claimed in claim 4, wherein the at least one sensor is an ultrasonic sensor.
